(19) United States
(12) Patent Application Publication
(10) Pub. No.: US 2023/0099321 A1
(43) Pub. Date: Mar. 30, 2023

(54) ELECTRIC DRIVELINE SYSTEM AND ELECTRIC DRIVELINE SYSTEM OPERATING METHOD

(71) Applicant: Dana Belgium N.V., Brugge (BE)

(72) Inventors: Bert HANNON, Brugge (BE); Joachim VAN DINGENEN, Drongen (BE)

(21) Appl. No.: 17/448,183

(22) Filed: Sep. 20, 2021

(51) Int. Cl. B60K 1/02; B60K 17/08; F16H 57/04; F16H 3/72; F16H 37/04

(52) U.S. Cl. CPC B60K 1/02; B60K 17/08; F16H 3/72; F16H 37/042; F16H 57/0415; F16H 57/0436; F16H 57/0484; F16H 2057/02034; F16H 2200/0034; F16H 2200/2005; F16H 2200/2035

(57) ABSTRACT

Methods and systems for and electric driveline are provided. The electric driveline system, in one example, includes an electric drive unit with a planetary gearset that includes a first gearset component that is rotationally coupled to a first electric machine and a second electric machine. The electric drive unit additionally includes an output shaft rotationally coupled to a second gearset component in the planetary gearset, a first friction clutch configured to selectively brake a third gearset component in the planetary gearset, and a second friction clutch configured to selectively couple the first gearset component to an output shaft.

### TECHNICAL FIELD

The present disclosure relates to a multi-speed electric driveline system and a method for operation of said driveline system.

### BACKGROUND AND SUMMARY

Multi-speed electric drive units such as electric axles have been deployed in certain electric vehicles (EVs) due to their higher responsiveness and gains in motor operating efficiency that the drive units afford, when compared to EVs using single speed geartrains. In these electric drive units, tradeoffs are made between the number of selectable gears and drive unit efficiency due to losses that arise from geartrains with more gears. Further, previous drive units with a relatively high number of selectable gears may pose packaging constraints on other vehicle systems such as the suspension and energy storage systems. Further, some prior powertrains have exhibited inefficiencies in cooling systems which use independent coolant loops for motor and drive unit cooling.

US 9,435,415 B2 to Gassmann discloses an electric axle for a motor vehicle. In one of the embodiments presented in Gassmann, the electric axle includes a switchable planetary drive with two planetary gear stages, which are coupled in parallel. The electric axle additionally includes a switching clutch with a sliding sleeve that allows the system to switch between multiple ratios by grounding two distinct ring gears in the system.

The inventors have recognized several drawbacks with Gassmann’s drive unit as well as other previous electric drivelines. Gassmann’s drive unit may exhibit space inefficiencies due to the use of a multi-stage planetary gear reduction. Consequently, difficulties may arise when attempting to package the drive unit into vehicle platforms with rigorous packaging demands. Using a multi-stage planetary reduction increases geartrain losses, when compared to electric axles with fewer stages. Further, the use of a single motor in Gassmann’s system increases the chance of vehicle inoperability caused by motor degradation, in comparison to multi-motor electric axles. Further, single motor electric axles may be less efficient than multi-motor electric axles, under certain operating conditions.

The inventors have recognized the aforementioned issues and developed an electric driveline system to at least partially overcome these issues. The driveline system includes an electric drive unit with a planetary gearset. The planetary gearset includes a first gearset component that is rotationally coupled to a first electric machine and a second electric machine. The electric drive unit further includes an output shaft that is rotationally coupled to a second gearset component in the planetary gearset. The output shaft is coupled to a differential or axle shafts. The electric drive unit further includes a first friction clutch that is configured to selectively brake a third gearset component in the planetary gearset. The system additionally includes a second friction clutch configured to selectively couple the first gearset component to an output shaft. Arranging multiple friction clutches in this manner enables the electric drive unit to efficiently shift between two gears in a compact geartrain that exhibits less losses than geartrains with greater numbers of stages. Further, using two electric machines in the system may permit the electric machines to be more efficiently operated and reduce the chance of driveline inoperability.

Further in one example, the first and second electric machines may be coaxially arranged. The coaxial arrangement of the electric machines allows the packaging efficiency of the system to be increased and manufacturing costs of the driveline system to be reduced, if desired.

In yet another example, the electric driveline system may further include a third electric machine that mechanically drives a lubricant pump. In such an example, the lubricant pump is in fluidic communication with one or more lubricant actuated components and lubricated components in the electric drive unit and elsewhere in the system. For instance, the lubricant pump may deliver oil to gears and bearings in the electric drive unit and/or a pair of wet brake devices coupled to the drive wheels. The lubricant pump may be controlled independently from vehicle wheel speeds, and therefore may be adjusted to fulfill the lubricant demands in the drive unit and increase drive unit efficiency in comparison to electric drive systems which drive oil pumps using traction motors.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a portion of a vehicle with a first example of an electric driveline system.

FIGS. 2A-2B show the power paths through the electric driveline system of FIG. 1 in a first gear configuration and a second gear configuration, respectively.

FIG. 2C shows a chart correlating clutch position and gear configuration in the electric driveline system operating states depicted in FIGS. 2A and 2B.

FIG. 3 shows a second example of an electric driveline system.

FIG. 4 shows a third example of an electric driveline system.

FIG. 5 shows a fourth example of electric driveline system.

FIGS. 6A-6C show mechanical, hydraulic, and electrical connections, respectively, in an electric driveline system of a vehicle.

FIG. 7 shows a method for operation of an electric driveline system.

### DETAILED DESCRIPTION

An electric driveline with an electric drive unit that compactly achieves at least two speeds with increased efficiency, when compared to previous electric powertrains, is described herein. The electric drive unit realizes this compact and high efficiency multi-speed architecture through the use of two electric machines which drive a sun gear in a planetary arrangement (e.g., a simple planetary gearset). In the planetary arrangement, at least two friction clutches are coupled to different gears. The first clutch selectively brakes one of the gears in the planetary assembly (e.g., the ring gear), and the second clutch selectively permits power transfer from the sun gear directly to an output shaft. In this way, the electric drive unit compactly achieves multi-speed functionality with greater efficiency when compared to previous electric drive units such as drive units with multi-stage planetary gearset arrangements.

The use of friction clutches in the system enables the electric drive unit to implement powershifting operation which reduces (e.g., substantially eliminates) torque interruptions during shifting transients. To further increase drive unit efficiency, a drive unit pump may be rotationally attached to a third electric machine that permits the pump to be strategically and independently operated to more closely fulfill the oil demands of the drive unit (e.g., oil demands for lubrication, component actuation, and/or cooling) when compared to pumps that are driven by a traction motor or internal combustion engine (ICE). For instance, the drive unit pump may distribute lubricant to wet wheel brakes or the wet clutches of the transmission, lubricated gears and bearings in the planetary gearset, and/or hydraulic clutch actuators in the drive unit. Still further, a driveline control unit (DCU) may be utilized for power management in the driveline system and specifically to augment the distribution of electric power to the inverters and the corresponding electric machines as well as control of the clutches. The DCU may electronically communicate with the vehicle control unit (VCU) to permit the DCU to receive a wider breadth of vehicle operating data to more efficiently manage power distribution.

The gear ratios of the electric drive unit may enable the drive unit to operate with a relatively high tractive effort in the first gear mode while achieving a relatively high cruising speed (e.g., maximum speed) in the second gear mode. For instance, the gear ratio of the electric drive unit in the first gear mode may be in the range 1.8-4.0 and the gear ratio of the electric drive unit in the second gear mode may be in the range 5.0-13.0.

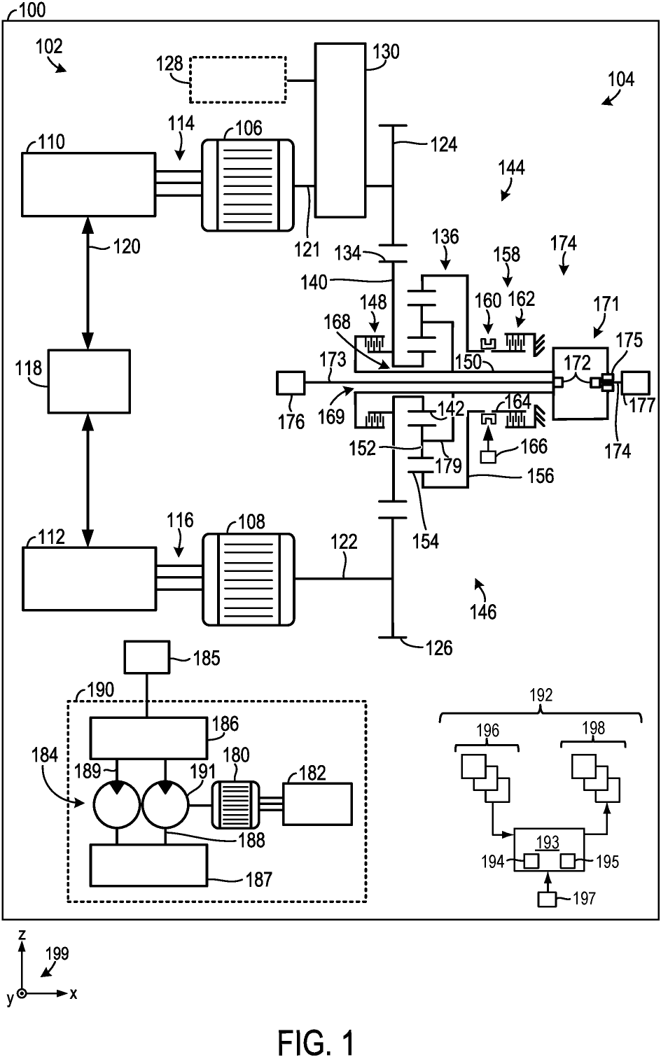

FIG. 1 depicts a vehicle 100 with an electric driveline system 102. As such, the vehicle 100 is an electric vehicle (EV) such as a battery electric vehicle (BEV). All-electric vehicles may specifically be used due to their reduced complexity and points of potential component degradation. However, hybrid electric vehicle (HEV) embodiments may be employed where the vehicle includes an internal combustion engine (ICE). Further, in one example, the vehicle may be an off-highway vehicle whose size and/or maximum speed may preclude it from operating on highways. For instance, the vehicle’s width may be greater than a highway lane and/or the maximum vehicle speed may be less than a minimum highway speed. However, in other examples, the vehicle may be an on-highway vehicle such as a commercial or passenger vehicle.

The electric driveline system 102 includes an electric drive unit 104 that is rotationally coupled to a first electric machine 106 and a second electric machine 108. Each of the electric machines 106, 108 may include conventional components such as a rotor and a stator that electromagnetically interact during operation to generate motive power. Furthermore, the electric machines may be motor-generators which also generate electrical energy during regeneration operation. Further, the electric machines may have similar designs and sizes, in one example. In this way, manufacturing efficiency may be increased. However, the electric machines may have differing sizes and/or component designs, in alternate examples.

Further, the electric machines 106, 108 may be multi-phase electric machines that are supplied with electrical energy through the use of a first inverter 110 and a second inverter 112. These inverters and the other inverters described herein are designed to convert direct current (DC) to alternating current (AC) and vice versa. As such, the electric machines 106, 108 as well as the other electric machines may be AC machines. For instance, the electric machines 106, 108 and the inverters 110, 112 may be three-phase devices, in one use-case example. However, motors and inverters designed to operate using more than three phases have been envisioned. The electrical connections between the inverters 110, 112 and the electric machines 106, 108 is indicated via lines 114, 116 (e.g., multi-phase wires).

The inverters 110, 112 may receive DC power from at least one electrical energy source 118 (e.g., an energy storage device such as a traction battery, a capacitor, combinations thereof, and the like, and/or an alternator). Arrows 120 indicate the flow of electrical energy from the energy source 118 to the electric machine 106, 108. Alternatively, each inverter may draw power from at least one distinct energy source. When both the inverters are coupled to one energy source, the inverters may operate at a similar voltage. Alternatively, if both inverters are coupled to distinct electrical energy sources, they may operate at different voltages, in some examples.

Output shafts 121, 122 of the electric machines 106, 108 have gears 124, 126 which reside thereon, respectively. The system 102 may further include a mechanical power take-off (PTO) 128 and a gear and clutch assembly 130 which provides mechanical power to the mechanical PTO 128. For instance, a gear reduction and a disconnect clutch may be provided in the gear and clutch assembly 130. As such, the gear and clutch assembly 130 may be designed to mechanically couple and decouple the mechanical PTO 128 from the electric machine 106 and/or drive unit output. Although the mechanical PTO 128 is designed to selectively rotationally couple to the first electric machine 106, the second electric machine 108 may, additionally or alternatively, have a mechanical PTO and an associated gear and clutch assembly coupled thereto.

The gears 124, 126 are each coupled to a gear 134 of a planetary gearset 136 in the electric drive unit 104. The gears described herein include teeth and mechanical attachment between the gears involves meshing of the teeth. The planetary gearset 136 may include a shaft 140 which connects the gear 134 to a sun gear 142. The gears 124, 126 may specifically be positioned on different sides 144, 146 of the electric drive unit 104 to enhance packaging and provide a more balanced weight distribution in the electric driveline system 102, if wanted.

A friction clutch 148 is coupled to the shaft 140 and designed to selectively rotationally couple the shaft to an output shaft 150. A friction clutch, as described herein, includes two sets of plates designed to frictionally engage and disengage one another while the clutch is closed and opened. As such, the amount of torque transferred through the clutch may be modulated depending on the degree of friction plate engagement. Thus, the friction clutches described herein may be operated with varying amounts of engagement (e.g., continuously adjusted through the clutch’s range of engagement). Further, the friction clutches described herein may be wet friction clutches through which lubricant is routed to increase clutch longevity. However, dry friction clutches may be used in alternate examples. The friction clutch 148 and the other friction clutches described herein may be adjusted via hydraulic, pneumatic, and/or electro-mechanical actuators. For instance, hydraulically operated pistons may be used to induce clutch engagement of the friction clutches. However, solenoids may be used for electro-mechanical clutch actuation, in other examples.

The sun gear 142 in the planetary gearset 136 is coupled to the shaft 140. Further, planet gears 152, in the planetary gearset 136, are coupled to the sun gear 142. Further, the planet gears 152 are mechanically coupled to a ring gear 154 in the planetary gearset 136. A shaft 156 extends from the ring gear 154 and has a second friction clutch assembly 158 residing thereon. The second friction clutch assembly 158 may include a synchronizer 160 arranged in series with a friction clutch 162. Placing the synchronizer 160 in series with the friction clutch 162 enables the electric drive unit’s efficiency to be increased when operating in the second gear. To elaborate, the synchronizer 160 permits a portion of the shaft 164 to be disconnected from the clutch 162 and freely rotate while the system operates in the second gear. As such, the plates in the clutch 162 may not rotate when the synchronizer is disengaged. Conversely, when the synchronizer is engaged, the shaft 164 and a hub in the clutch 162 may rotate in unison.

The synchronizer 160 is designed to synchronize the speed of the shaft 156 and a shaft 164 coupled to the friction clutch 162, and mechanically lock rotation of the shafts 156, 164, when engaged. For instance, the synchronizer 160 may include a sleeve with splines, ramped teeth, and the like to achieve the aforementioned functionality. A shift fork or other suitable actuator, schematically indicated at 166, may be used to engage and disengage the synchronizer. To increase system compactness, the friction clutches 148, 162 as well as the output shaft 150 may be coaxially arranged. To permit this coaxial arrangement, the sun gear 142 may include an opening 168 through which the output shaft 150 extends. Further, the output shaft 150 includes an opening 169 through which an axle shaft 173 extends. As such, the axle shaft 173, the output shaft 150, and the sun gear 142 may be coaxially arranged. In this way, drive unit compactness may be increased when compared to drive units with an output shaft which is not coaxially arranged with a planetary assembly.

The friction clutch 162 is designed to ground the ring gear 154. To accomplish the ring gear grounding, the friction clutch 162 may include a housing with a portion of the friction plates coupled thereto and fixedly attached to a stationary component, such as the electric drive unit’s housing. A bearing may be positioned between the shaft 156 and the output shaft 150 to enable these shafts to independently rotate, during certain conditions.

The output shaft 150 may be coupled to a differential 171. The differential generally includes output interfaces 172 that are contoured to attach to axle shafts 173, 174. A bearing 175 may be included in the differential and permits the axle shaft 174 to rotate. The differential 171 may be an open differential, a limited slip differential, or a torque vectoring differential. The open differential may include a differential case which has spider gears attached thereto and the spider gears in turn mesh with the side gears to permit speed differentiation between the output interfaces. The limited slip differential may include a clutch pack assembly with friction discs that are designed to constraint the maximum speed differentiation between the differential’s output interfaces and the axle shafts to which the interfaces are attached. In the torque vectoring differential example, the differential may include clutch packs which may be electromagnetically, hydraulically, or pneumatically actuated which allows the speed differentiation permitted by the differential to be adjusted.

The differential 171 is coupled to wheel, brake, and hub assemblies 176, 177. The hubs permit the drive wheels to rotate and the brake devices (e.g., wet brakes, disc brakes, drum brakes, and the like) permit wheel speed to be slowed. In the case of wet brakes, the brakes may receive lubricant from a pump 184, discussed in greater detail herein. The brakes may be hydraulically actuated, in one example. Each wheel, brake, and hub assembly may include at least one wheel, brake, and hub. However, multi-wheel brake, and hub assemblies have been contemplated. Further the brakes are illustrated in assemblies that are spaced away from the electric drive unit. However, in other examples, the brakes may be spaced away from the hubs. For instance, the brakes may be positioned within the electric drive unit, in other embodiments.

The planet gears 152 rotate on a carrier 179 of the planetary gearset 136. The carrier 179 is rotationally coupled to the output shaft 150. The planetary gearset 136 may be a simple planetary gearset that solely includes the sun gear 142, ring gear 154, planet gears 152, and carrier 179. By using a simple planetary assembly, electric drive unit compactness may be increased when compared to more complex planetary assemblies such as multi-stage planetary assemblies, Ravigneaux planetary assemblies, and the like. Consequently, the driveline system may pose less space constraints on other vehicle components, thereby permitting the system’s applicability to be expanded. Further, losses in the electric drive unit may be decreased when a simple planetary gearset is used as opposed to more complex gear arrangements.

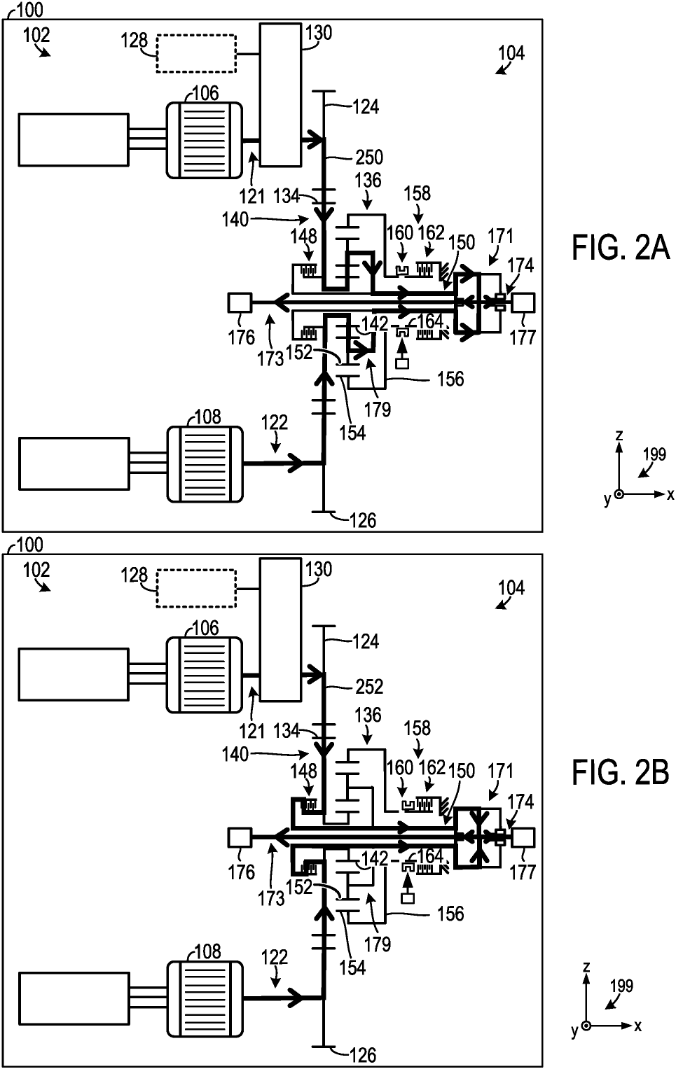

Depending on the gear ratio of the electric drive unit, mechanical power may travel through the carrier 179 to the output shaft 150 or from the sun gear 142 to the output shaft. Mechanical power paths through the electric drive unit in the different gears and shifting operation (e.g., powershifting operation) between the operating gears are discussed in greater detail herein with regard to FIGS. 2A-2B.

A third electric machine 180 and inverter 182 may be provided in the system 102. The third electric machine 180 is designed to drive an electric drive unit pump 184 which generates the flow of a fluid (e.g., a lubricant such as oil) through the electric drive unit 104. It will be understood that lubricant as described herein is a fluid such as oil that may be used for lubricating components as well as for component actuation and/or cooling. The valve 186 may be in fluidic communication with components 185 (schematically depicted in FIG. 1) in the electric drive unit 104 that receive lubricant. The lubricant may be routed to the desired components via lubricant conduits, jets, additional valves, manifolds, and the like. Further, the components 185 may include gears, clutches, hydraulic pistons for clutch actuation, and the like.

Once the lubricant is routed from the valve 186 to the lubricated components, the lubricant returns to a sump 187. Additionally, the sump 187 may be located in an electric drive unit housing and profiled to gather lubricant from the lubricated components in the electric drive unit. The pump 184 receives lubricant from the sump 187 via pick-up conduits 188. Conversely, the pump outlets 189 deliver lubricant to the valve 186. It will be understood that the pump 184, the valve 186, and the sump 187 are included in a lubrication system 190. The lubrication system 190 may further include conduits for routing the lubricant to targeted components in the electric drive unit such as the planetary gearset, clutches, and the like. The pump is illustrated in FIG. 1 as a double pump with two pump modules 191, but other pump designs have been contemplated.

Further, by using a separate electric machine to drive the electric drive unit pump 184, the electric machine’s speed and therefore pump speed may be adjusted to track with the lubricant demands in the electric drive unit. For instance, the pump speed may be increased during shifting transients and then decreased while the electric drive unit is sustained in one of the two discrete operating gears. This reduces hydraulic losses and allows the hydraulic system to be downsized, if desired.

The third electric machine 180 and the inverter 182 may be operated at a lower voltage than the first and second electric machines 106, 108 and corresponding inverters. For instance, the lower voltage may be in the following range: 12 Volts (V)-144 V and the higher voltage may be in the following range: 350 V-800 V, in one use-case example. However, other lower and higher voltage values may be used, in other examples. In this way, the electric drive unit’s efficiency may be increased. However, in other examples, the first electric machine 106, the second electric machine 108, and the third electric machine 180 may be operated at a similar voltage (e.g., a higher voltage within the range of 350 V-800 V or a lower voltage with the range of 12 V-144 V).

The vehicle 100 may further include a control system 192 with a controller 193 as shown in FIG. 1. The controller 193 may include a microcomputer with components such as a processor 194 (e.g., a microprocessor unit), input/output ports, an electronic storage medium 195 for executable programs and calibration values (e.g., a read-only memory chip, random access memory, keep alive memory, a data bus, and the like). The storage medium may be programmed with computer readable data representing instructions executable by a processor for performing the methods and control techniques described herein as well as other variants that are anticipated but not specifically listed.

The controller 193 may receive various signals from sensors 196 coupled to various regions of the vehicle 100 and specifically the electric drive unit 104. For example, the sensors 196 may include a pedal position sensor designed to detect a depression of an operator-actuated pedal such as an accelerator pedal and/or a brake pedal, a speed sensor at the drive unit output shaft, energy storage device state of charge (SOC) sensor, clutch position sensors, and the like. Motor speed may be ascertained from the amount of power sent from the inverter to the electric machine. An input device 197 (e.g., an accelerator pedal, a brake pedal, a drive mode selector such as a gear selector, combinations thereof, and the like) may further provide input signals indicative of an operator’s intent for vehicle control.

Upon receiving the signals from the various sensors 196 of FIG. 1, the controller 193 processes the received signals, and employs various actuators 198 of vehicle components to adjust the components based on the received signals and instructions stored on the memory of controller 193. For example, the controller 193 may receive an accelerator pedal signal indicative of an operator’s request for increased vehicle acceleration. In response, the controller 193 may command operation of the inverters to adjust electric machine power output and increase the power delivered from the machines to the electric drive unit 104. The controller 193 may, during certain operating conditions, be designed to send commands to the clutches 148, 162 to engage and disengage the clutches. For instance, a control command may be sent to a clutch assembly and in response to receiving the command an actuator in the clutch assembly may adjust the clutch based on the command. The other controllable components in the vehicle and more particularly the electric driveline system may function in a similar manner with regard to sensor signals, control commands, and actuator adjustment, for example.

The controller 193 may be designed to control the clutches 148, 162 to synchronously shift between two of the electric drive unit’s operating gears. Further, the controller 193 may be designed to allocate mechanical power distribution to the mechanical PTO 128 and the planetary gearset 136 via operation of the gear and clutch assembly 130 based on a prioritization of a PTO power demand and a traction power demand. For instance, if PTO power demand is of a higher priority than the traction power demand and the PTO power demand increases, a clutch in the assembly 130 may be operated to decouple the PTO and the electric machine 106 from the drive unit output. Conversely, if traction power demand is of a higher priority than the PTO power demand and the traction power demand increases, the clutch in the assembly 130 may be operated to sustain connection or reconnect the PTO and the electric machine 106 to the drive unit output. In this way, power distribution from the electric machine may match a prioritization of traction and PTO power set by the vehicle operator, for instance.

An axis system 199 is provided in FIG. 1, FIGS. 2A-2B, and FIGS. 3-5, for reference. The z-axis may be a vertical axis (e.g., parallel to a gravitational axis), the x-axis may be a lateral axis (e.g., horizontal axis), and/or the y-axis may be a longitudinal axis.

The electric drive unit 104 has two clutches that enable it to function as a two-speed electric drive unit. However, in other embodiments, additional clutches may be added to the electric drive unit to enable it to function with a greater number of selectable gears. As such, the electric drive unit may have three or more speeds, in other embodiments.

In the first and second gears, depicted in FIGS. 2A and 2B, power bypasses the PTO 128 and flows to the gear 124 from the electric machine 106. To accomplish the PTO bypass functionality, the gear and clutch assembly 130 may be adjusted to disconnect the PTO from the output shaft 121 of the electric machine 106. However, in other examples, at least a portion of the power from the electric machine 106 may be directed to the mechanical PTO 128 by way of the gear and clutch assembly 130.

FIGS. 2A and 2B show the power paths through the electric drive unit 104 in the electric driveline system 102 in a first gear configuration and a second gear configuration, respectively, referred to as first and second gear modes. The power paths specifically correspond to drive mode operation (e.g., forward drive mode operation) in the system. It will be appreciated that the electric drive unit’s gear ratio in the first gear mode is higher than the gear ratio in the second gear mode. Thus, the first gear may be used during launch and subsequent acceleration while the second gear may be used for cruising operation, for instance.

Turning specifically to FIG. 2A, while the electric drive unit 104 is operating in the first gear mode, the ring gear 154 is held stationary by the friction clutch 162 and the clutch 148 is disengaged. The mechanical power path in the first gear mode (denoted via arrows 250) unfolds as follows: mechanical power moves from the first and second electric machines 106, 108 to the gear 124, 126, respectively, from the gears 124, 126 to the gear 134, from the gear 134 to the sun gear 142, from the sun gear to the planet gears 152, from the planet gears to the carrier 179, from the carrier to the output shaft 150, from the output shaft to the differential 171, and from the differential to the axle shafts 173, 174. From the axle shafts 173, 174, the power path travels to the drive wheels in the wheel, brake, and hub assemblies 176, 177, respectively.

While the electric drive unit 104 is operating in the second gear mode, as shown in FIG. 2B, the clutch 148 is engaged to permit mechanical power transfer between the gear 134 and the output shaft 150 and the clutch 162 is disengaged. In the second gear mode, the mechanical power path (denoted via arrows 252) unfolds as follows: mechanical power moves from the first and second electric machines 106, 108 to the gears 124, 126, respectively, from the gears 124, 126 to the gear 134, from the gear 134 to the clutch 148, from the clutch 148 to the output shaft 150, from the output shaft to the differential 171, and from the differential to the axle shafts 173, 174. From the axle shafts 173, 174, the power path travels to the drive wheels in the wheel, brake, and hub assemblies 176, 177, respectively.

FIG. 2C shows a chart 260 that correlates the configurations of the friction clutches 148, 162 and the synchronizer 160 to the first and second gear modes. An “X” denotes clutch engagement and a blank field conversely denotes clutch disengagement. Specifically, in the first gear mode, the friction clutch 148 is disengaged and the friction clutch 162 as well as the synchronizer 160 are engaged. Conversely, in the second gear mode, the friction clutch 148 is engaged and the friction clutch 162 as well as the synchronizer 160 are disengaged. To powershift between the first gear and the second gear, the clutch 148 may be engaged while the clutch 162 is disengaged. Subsequently to disengagement of the clutch 162, the synchronizer 160 may be disengaged. Conversely, to shift from the second gear back to the first gear, the synchronizer 160 may first be engaged and subsequently the clutch 162 may be engaged while the clutch 148 is disengaged. It will be understood that the synchronizer may be omitted from the system, in some examples. When powershifting is implemented in the electric drive unit, power interruptions during shifting may be substantially avoided, thereby enhancing shifting performance.

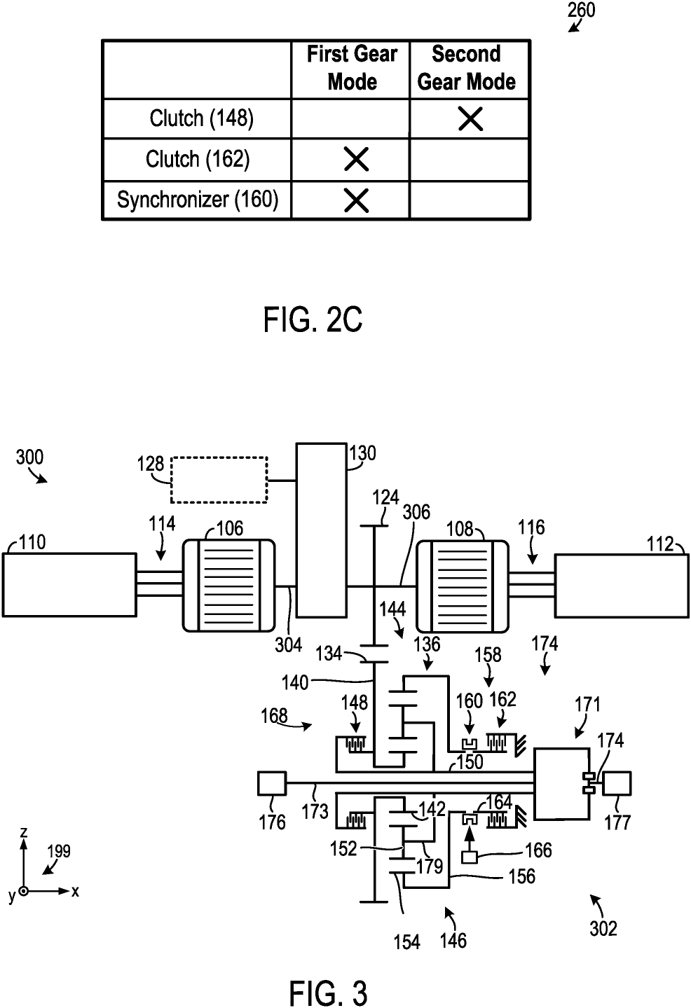

FIGS. 3-5 show different electric driveline system embodiments. These driveline system embodiments have certain dissimilarities in comparison to the electric driveline system 102 shown in FIGS. 1-2B and these dissimilarities are described in greater detail herein. However, these electric driveline system embodiments may share some common components with the electric driveline system 102 shown in FIGS. 1-2B. For instance, the driveline systems shown in FIGS. 3-5 each includes electric machines 106, 108, planetary gearset 136, and axle shafts 173, 174. Similar components are similarly numbered and redundant description of the other overlapping components in the systems is omitted for concision.

FIG. 3 specifically illustrates an electric driveline system 300 with an electric drive unit 302 where the electric machines 106, 108 included therein are coaxially arranged. Specifically, the output shafts 304, 306 of the electric machines 106, 108 are coaxially arranged. The coaxial arrangement of the electric machines allows the drive unit’s packaging efficiency to be increased and manufacturing costs to be reduced, if wanted.

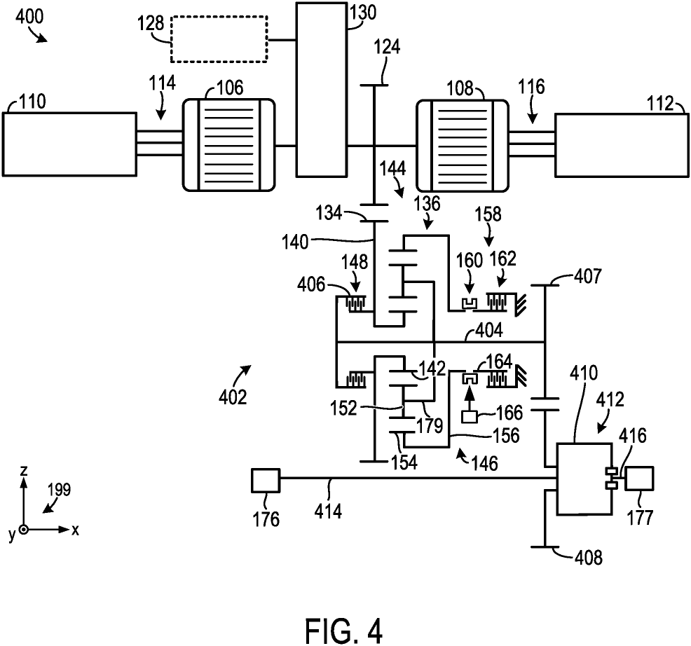

FIG. 4 shows an electric driveline system 400 with an electric drive unit 402. The electric machines 106, 108 are again coaxially arranged which permits the system to achieve the packaging efficiency gains. The electric drive unit 402 shown in FIG. 4 includes a shaft 404 rotationally coupled to the carrier 179 and selectively coupled a drum 406 of the clutch 148. Thus, the clutch 148 is designed to selectively couple the shaft 140 to the shaft 404 such that they corotate. A gear 407 is fixedly coupled to the shaft 404. A gear 408 meshes with the gear 407 and is coupled to a case 410 of a differential 412. Axle shafts 414, 416 are rotationally coupled to the differential 412 and the wheel, brake, and hub assemblies 176, 177, respectively. Using the gear reduction formed by gears 407 and 408 enables the drive unit’s drop to be increased which may be desirable from a packaging perspective, in certain vehicle platforms.

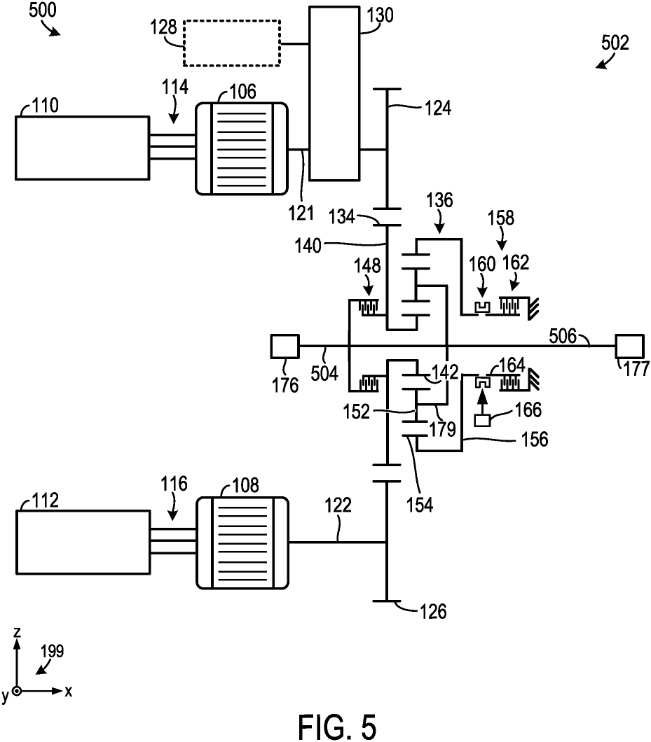

FIG. 5 shows an electric driveline system 500 with an electric drive unit 502. The differential is omitted from the electric drive unit 502, illustrated in FIG. 5. Instead, shafts 504, 506 have a dual-use functionality. Therefore, the shafts 504, 506 function as the output shaft of the drive unit and serve as axle shafts which connect the drive unit to the wheel, brake, and hub assemblies 176, 177, respectively. In this way, the driveline system may be simplified and the manufacturing and repair costs may be reduced, if desired.

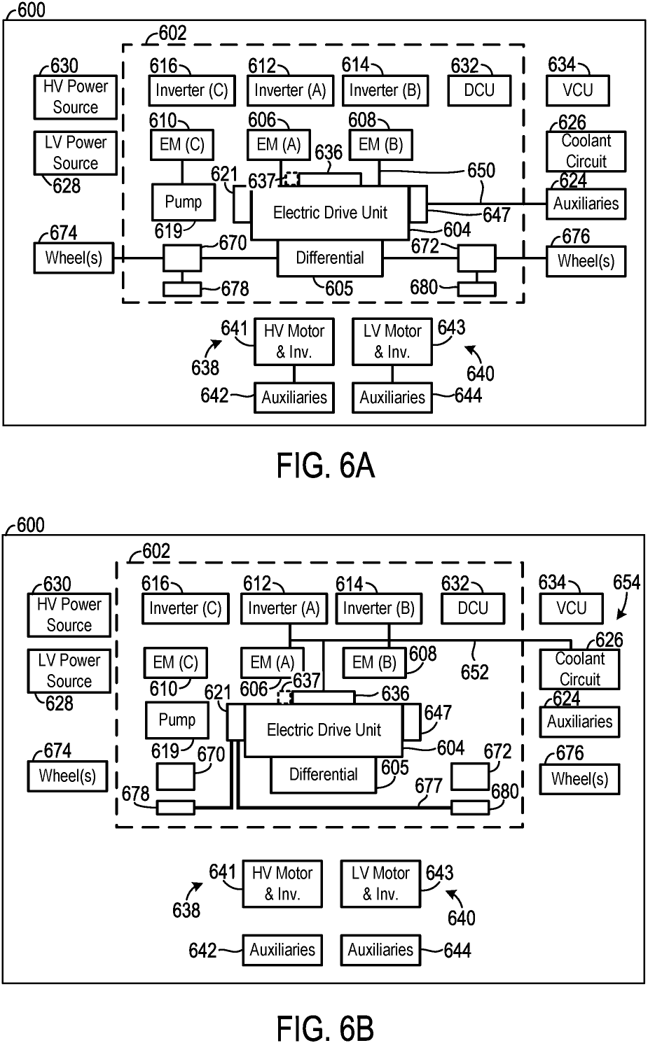

FIGS. 6A-6C show another example of a vehicle 600 with an electric driveline system. The boundary of the electric driveline system is denoted via dashed lines 602. However, the system may include a different grouping of components, in other examples. The electric driveline system 602 includes an electric drive unit 604. The electric driveline system 602 with the electric drive unit 604 shown in FIGS. 6A-6C may share common features with the electric driveline system 102 and the electric drive unit 104 shown in FIGS. 1-2B. Redundant description is therefore omitted. FIGS. 6A-6C specifically illustrate the mechanical, coolant, and electrical connections, respectively, between components in the electric driveline system 602 as well as other vehicle components. Although the mechanical, coolant, and electrical connections are illustrated in separate figures for clarity, it will be understood that these connections may all be present in the electric driveline system.

The driveline system 602, shown in FIGS. 6A-6C, include a first electric machine 606, a second electric machine 608, and a third electric machine 610. The electric driveline system 602 further includes a first inverter 612, a second inverter 614, and a third inverter 616 that are associated with the first electric machine 606, the second electric machine 608, and the third electric machine 610, respectively. The vehicle 600 further includes a pump 619 that is designed to circulate lubricant (e.g., oil) in the electric drive unit 604. A valve 621 coupled to the electric drive unit 604 may be used to regulate lubricant flow from the pump 619 to the electric drive unit 604. The driveline system 602 may further include a first hub assembly 670, a second hub assembly 672, drive wheels 674, 676, and brake devices 678, 680. The brake devices may be wet brakes, as previously discussed, although other suitable brakes such as dry disc brakes and drum brakes, have been contemplated. Further, the first and second hub assemblies 670, 672 may provide interfaces for the drive wheels 674, 676 and may, in certain cases, each include an additional gear reduction. The valve 621 may additional be designed to flow oil to the brake devices 678, 680.

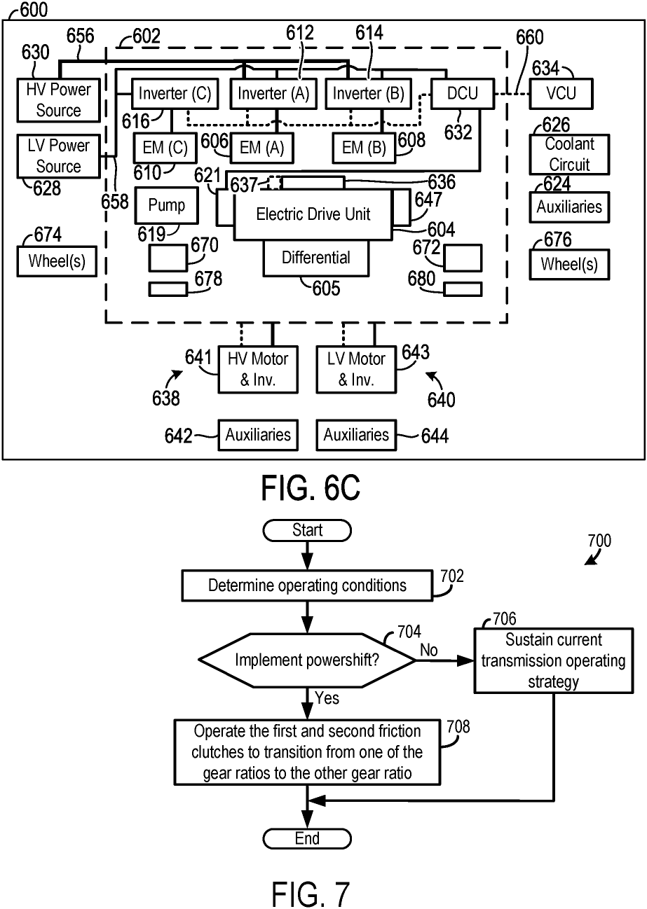

The vehicle 600 may further include auxiliary devices 624, such as a steering pump an air conditioning pump, a hydraulic pump for working functions, and the like. Still further, the vehicle may include a coolant circuit 626, a lower voltage power source 628 (e.g., a battery, a capacitor, combinations thereof, and the like), and a higher voltage power source 630 (e.g., a battery, a capacitor, combinations thereof, and the like). The driveline system 602 may include a DCU 632 and the vehicle 600 may include a VCU 634. However, other control unit arrangements have been contemplated, such as a common control unit which is used to adjust operation of both the driveline system 602 and components in the vehicle 600. Each of the control units may include any know data storage mediums (e.g., random access memory (RAM), read only memory (ROM), keep alive memory, combinations thereof, and the like) and a processor (e.g., micro-processor unit) designed to execute instructions stored in the data storage mediums. As such, the DCU 632 and/or the VCU 634 may perform the control methods, techniques, schemes, etc. described herein such as the method shown in FIG. 7. Further the DCU may be designed to coordinate operation of the inverters 612, 614, and 616 to increase the system’s efficiency. Additionally, the use of the DCU 632 in the system may reduce integration complexity for customers (e.g., original equipment manufacturers (OEMs)) and allow for a more integrated control approach. For instance, the DCU may coordinate regenerative braking and the use of a service brake. In another example, the DCU may implement a limp home mode when minor component degradation is detected, such as a degradation of a speed sensor. Further, the DCU may shutdown if the controller area (CAN) is degraded, in some scenarios.

A heat exchanger 636 may be coupled to (e.g., directly coupled to or incorporated into) the electric drive unit 604. In other examples, the heat exchanger 636 may be coupled to a vehicle frame 637. The heat exchanger 636 may include components for transferring thermal energy between a coolant circuit and an oil circuit, such as adjacent coolant and oil passages, a housing, and the like. In this way, heat may be efficiently removed from the electric drive unit’s lubrication circuit. Using a heat exchanger that is incorporated into the electric drive unit in this manner, may reduce the amount of coolant interfaces for the customers. Customer satisfaction may be correspondingly increased.

Electric PTOs 638, 640 may further be included in the vehicle 600. The electric PTO 638 may include a higher voltage motor and an inverter 641 coupled to auxiliary devices 642 (e.g., a steering pump, an air conditioning pump, a hydraulic pump for working functions, and the like). The electric PTO 640 may include a lower voltage motor and an inverter 643 coupled to auxiliary devices 644. Providing electric PTOs in the vehicle expands the vehicle’s capabilities and adaptability. Consequently, the driveline system may be used in a wider variety of vehicle platforms. Furthermore, by using electric PTOs that operate with different voltages, the motors in the PTOs may be granularly tuned to meet the demands of the specific auxiliary devices to which they are attached, if wanted. However, in other examples, the electric PTO may be operated using a similar voltage.

A mechanical power take-off (PTO) 647 may further be coupled to the electric drive unit 604 and the auxiliary devices 624. Providing the mechanical PTO 647 in the driveline system allows the system’s applicability to be expanded.

FIG. 6A maps the mechanical connections between the components in the driveline system 602 as well as the vehicle 600. These mechanical connections are denoted via lines 650. The mechanical connections may be formed via shafts, joints, belts, chains, combinations thereof, and the like. As shown, the first electric machine 606 and the second electric machine 608 are rotationally coupled to the electric drive unit 604. Providing two electric machines mechanically coupled to the electric drive unit may permit driveline efficiency to be increased. Further, the likelihood of the driveline system becoming inoperable due to motor degradation is reduced when there is electric machine redundancy in the driveline system.

The electric drive unit 604 may also be rotationally coupled to a differential 605. However, the differential may be omitted from the drive unit, in alternate examples. The differential 605 is rotationally coupled to axle shafts that extend through the hub assemblies 670, 672 and are rotationally coupled to the drive wheels 674, 676, respectively. Brake devices 678, 680 are coupled to the hub assemblies 670, 672 and are designed to slow the speed of the drive wheels 674, 676. As previously discussed, the brakes may be wet brakes although dry disc brakes or drum brakes may be alternatively used.

The third electric machine 610 may be rotationally coupled to the pump 619, and the pump may be in fluidic communication with the electric drive unit 604 via the valve 621. The third electric machine 610 may be operated independently from the first and second electric machines 606, 608. To elaborate, the third electric machine 610 may be adjusted to track with the lubricant demands of the electric drive unit. In this way, the system’s efficiency can be increased without impacting electric drive unit lubrication operation, if wanted.

The mechanical PTO 647 is mechanically coupled to the auxiliary devices 624. Further, the electric PTOs 638, 640 are mechanically coupled to the auxiliary devices 642, 644, respectively. In this way, the system’s PTO capabilities may be expanded to meet a variety of auxiliary device demands across a wide breadth of vehicle platforms. The system’s customer appeal is consequently increased.

FIG. 6B shows the coolant connections, denoted via lines 652, in a cooling assembly 654 of the electric driveline system 602. The coolant connections may be established via conduits, ducts, and the like which are routed (e.g., internally and/or externally routed) through various system components. The coolant may include water and/or glycol. The cooling assembly 654 may include the coolant circuit 626 which may have a coolant pump and a heat exchanger. As shown, coolant may be routed to the heat exchanger 636, the first electric machine 606, the second electric machine 608, the first inverter 612, and the second electric machine 608 in parallel. Additionally or alternatively, the coolant may be routed to one or more of the following components in series: the heat exchanger 636, the first electric machine 606, the second electric machine 608, the first inverter 612, and the second electric machine 608. In this way, the electric machines, inverters, and electric drive unit lubricant may be efficiently cooled. The heat exchanger 636 is designed to transfer heat from lubricant (e.g., oil) routed through the electric drive unit to coolant in the cooling assembly 654. Providing the heat exchanger with an oil to coolant heat transfer functionality permits a liquid to air heat exchanger, such as a radiator, to be omitted from the system, if wanted. The system’s size, complexity, and/or manufacturing costs may be reduced, as a result.

Alternatively, the first and/or second electric machines 606, 608 as well as the first and/or second inverters 612, 614 may be oil cooled. In such an example, the heat exchanger 636 may be omitted from the system. However, in another example, the inverters may be water cooled and the motors may be oil cooled. In such an example, the heat exchanger 636 may be utilized in the system.

FIG. 6B additionally depicts oil flow in the electric driveline system 602 which is denoted via lines 677. Specifically, oil may flow between the valve 621 and the brake devices 678, 680, as previously discussed.

FIG. 6C shows electrical and data connections in the vehicle 600 and the electric driveline system 602. The electrical connections are specifically divided into higher voltage connections (denoted by thicker lines 656) and lower voltage connections (denoted by thinner lines 658). Data connections are denoted via dashed lines 660. The higher voltage connections emanate from the higher voltage power source 630 and the lower voltage connections emanate from the lower voltage power source 628. In one use-case example, the lower voltage may be in the following range: 12 V-144 V and the higher voltage may be in the following range: 350 V-800 V. However, other suitable higher and lower voltage values may be used, in other embodiments.

The higher voltage power source 630 may be electrically coupled to the first inverter 612 and the second inverter 614. Likewise, higher voltage electrical connections may be established between the first and second electric machines 606, 608 and the first and second inverters 612, 614. A higher voltage connection may additionally be established between the electric PTO 638 and the driveline system 602.

The lower voltage power source 628 may be electrically coupled to the first inverter 612, the second inverter 614, the third inverter 616, and/or the DCU 632. A lower voltage connection may additionally be established between the third inverter 616 and the third electric machine 610 as well as the electric PTO 640 and the driveline system 602. Further, a lower voltage connection may be established between the DCU 632 and the valve 621.

Data connections may be established between the VCU 634 and the DCU 632. For instance, operating condition data such as vehicle speed, pedal position (e.g., brake pedal position and/or accelerator pedal position), drive mode selector positon, and the like may be transferred from the VCU to the DCU. Conversely, operating condition data such as electric machine speed, electric machine temperature, power source SOC, clutch position, electric drive unit temperature, and the like may be transferred from the DCU to the VCU. In this way, data may be shared between the DCU and the VCU to enhance control routines at each control unit. A data connection may also be established between the DCU 632 and the first inverter 612, the second inverter 614, and/or the third inverter 616. Further, data may be transferred from the electric PTOs 638 and 640 to the driveline system 602.

FIG. 7 shows a method 700 for operation of an electric driveline system. The method 700 may be carried out by any of the electric driveline systems 102, 300, 400, 500, and 602 or combinations of the systems discussed above with regard to FIGS. 1-6C, in one example. However, in other examples, the method 700 may be implemented by other suitable electric driveline systems. Instructions for carrying out method 700 may be implemented by a controller, such as the controller 193 in FIG. 1 or the DCU 632 and/or the VCU 634 in FIGS. 6A-6C, by executing instructions stored on a memory of the controller and in conjunction with signals received from sensors at the controller. The controller may employ actuators in different system components to implement the method steps described below.

At 702, the method includes determining operating conditions. The operating conditions may include speeds of the electric machines, electric drive unit output shaft speed, vehicle speed, clutch positon, pedal position, electric drive unit load, and the like.

At 704, the method judges if the electric drive unit should be powershifted between two of the operating gear ratios. The powershift judgement may be carried out based on an electric drive unit speed and/or load threshold that may trigger a shift event in the electric drive unit.

If it is judged that the electric drive unit should not be powershifted between gears (NO at 704), the method moves to 706. For instance, the vehicle speed may remain in a range above or below a threshold that triggers a shifting event. At 706, the method includes sustaining the current electric drive unit operating strategy. For instance, the electric drive unit may be held in its current operating gear by sustaining engagement of one of the friction clutches and disengagement of the other friction clutch.

Conversely, if it is judged that the electric drive unit should be powershifted between two of the electric drive unit’s operating gears (YES at 704) the method moves to 708. For example, the vehicle speed may surpass or fall below a threshold speed that triggers an electric drive unit shift event. At 708, the method includes operating a first friction clutch and a second friction clutch to transition from one gear ratio to another. For instance, when shifting from the first gear to the second gear, the first clutch (e.g., clutch 162, shown in FIG. 1) may be disengaged while the second clutch (e.g., clutch 148, shown in FIG. 1) is engaged. Through the coordinated (e.g., simultaneous) engagement and disengagement of the clutches in this manner, power interruptions during shifting transients may be reduced, thereby increasing electric drive unit efficiency.

The technical effect of the electric driveline system operating method described herein is to efficiently shift between two of the drive unit operating gears with a reduced amount of power interruption. The electric drive unit efficiency may be consequently increased and noise, vibration, and harshness (NVH) during shifting transients may be reduced, thereby enhancing customer satisfaction.

FIGS. 1-2B and 3-6C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, an electric driveline system is provided that comprises an electric drive unit including: a planetary gearset comprising a first gearset component that is rotationally coupled to a first electric machine and a second electric machine; a first friction clutch configured to selectively brake a second gearset component in the planetary gearset; and a second friction clutch configured to selectively couple the first gearset component to an output shaft, wherein the output shaft is coupled to a differential or axle shafts; wherein the first friction clutch and the second friction clutch configured to shift the planetary gearset between a first gear configuration and a second gear configuration; and wherein the planetary gearset includes a third gearset component that is rotationally coupled to at least a pair of drive wheels.

In another aspect, a method for operation of an electric driveline system is provided that comprises transferring rotational energy to a sun gear of a planetary gearset from a first electric machine and a second electric machine; and shifting between a first gear configuration and a second gear configuration via: engagement of a first friction clutch coupled to a ring gear of the planetary gearset; and disengagement of a second friction clutch coupled to the sun gear of the planetary gearset; and transferring rotational energy to a differential or axle shafts from a carrier in the planetary gearset. In one example, the method may further comprise transferring rotational energy from the first electric machine to a mechanical power take-off (PTO) through operation of a PTO clutch coupled to an output shaft of the first electric machine and the PTO. In yet another example, the method may further comprise transferring electric energy from a lower or higher voltage inverter to the third electric machine; and transferring electric energy from lower or higher voltage inverters to the first and second electric machines.

In yet another aspect, an electric driveline system is provided that comprises an electric drive unit including: a planetary gearset with a sun gear rotationally coupled to a first electric machine and a second electric machine; a differential rotationally coupled to a carrier in the planetary gearset; a first friction clutch and a synchronizer coupled to a ring gear in the planetary gearset; and a second friction clutch coupled to the sun gear; and a driveline control unit (DCU) including instructions that when executed cause the DCU to: operate the first friction clutch and the second friction clutch to synchronously shift between a first gear configuration and a second gear configuration.

In any of the aspects or combinations of the aspects, the electric driveline system may further comprise a synchronizer configured to decouple the first friction clutch from the ring gear.

In any of the aspects or combinations of the aspects, the output shaft may include a central opening with an axle shaft that extends therethrough.

In any of the aspects or combinations of the aspects, the electric driveline system may further comprise a third electric machine mechanically driving a lubricant pump.

In any of the aspects or combinations of the aspects, the third electric machine may receive electric power from a lower voltage inverter and the first and second electric machines receive electric power from higher voltage inverters; or the first electric machine, the second electric machine, and the third electric machine may receive electric power from inverters that operate with a similar voltage.

In any of the aspects or combinations of the aspects, the lubricant pump may be in fluidic communication with one or more lubricant actuated components and lubricated components in the electric drive unit and/or a pair of brake devices coupled to the pair of drive wheels.

In any of the aspects or combinations of the aspects, the first and second electric machines may be coaxially arranged.

In any of the aspects or combinations of the aspects, the electric driveline system may further comprise a final gear reduction positioned between the differential and the carrier.

In any of the aspects or combinations of the aspects, an axle shaft may be coupled to the differential and extends through an opening in the sun gear.

In any of the aspects or combinations of the aspects, the electric driveline system may further comprise a heat exchanger coupled to a housing of the electric drive unit or a vehicle frame and configured to circulate a water based coolant therethrough.

In any of the aspects or combinations of the aspects, the electric driveline system may further comprise a mechanical power take-off (PTO) coupled to an output shaft of the first electric machine or the second electric machine.

In any of the aspects or combinations of the aspects, engagement of the first friction clutch and disengagement of the second friction clutch may be synchronously implemented.

In any of the aspects or combinations of the aspects, the differential and the planetary gearset may be coaxially arranged and wherein the differential may be an open differential, a limited slip differential, or a torque vectoring differential.

In another representation, an electric drive axle is provided that comprises a simple planetary gearset with a first friction clutch that is designed to brake a ring gear in the planetary gearset and a second friction clutch that is designed to rotationally couple a sun gear in the planetary gearset directly to an output shaft that provides mechanical power to a differential or directly to axle shafts.

Note that the example control and estimation routines included herein can be used with various powertrain, electric drive unit, and/or vehicle system configurations. The control methods and routines disclosed herein may be stored as executable instructions in non-transitory memory and may be carried out by the control system including the controller in combination with the various sensors, actuators, and other driveline system and/or vehicle hardware in combination with the electronic controller. As such, the described actions, operations, and/or functions may graphically represent code to be programmed into non-transitory memory of the computer readable storage medium in the vehicle and/or driveline control system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or drive units. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric driveline system, comprising:
an electric drive unit including:
a planetary gearset comprising a first gearset component that is rotationally coupled to a first electric machine and a second electric machine;
a first friction clutch configured to selectively brake a second gearset component in the planetary gearset; and
a second friction clutch configured to selectively couple the first gearset component to an output shaft, wherein the output shaft is coupled to a differential or axle shafts;
wherein the first friction clutch and the second friction clutch configured to shift the planetary gearset between a first gear configuration and a second gear configuration; and
wherein the planetary gearset includes a third gearset component that is rotationally coupled to at least a pair of drive wheels.

2. The electric driveline system of claim 1, further comprising a synchronizer configured to decouple the first friction clutch from the second gearset component.

3. The electric driveline system of claim 1, wherein the output shaft includes a central opening with an axle shaft that extends therethrough.

4. The electric driveline system of claim 1, further comprising a third electric machine mechanically driving a lubricant pump.

5. The electric driveline system of claim 4, wherein:
the third electric machine receives electric power from a lower voltage inverter and the first and second electric machines receive electric power from higher voltage inverters; or
the first electric machine, the second electric machine, and the third electric machine receive electric power from inverters that operate at a similar voltage.

6. The electric driveline system of claim 4, wherein the lubricant pump is in fluidic communication with one or more lubricant actuated components and lubricated components in the electric drive unit and/or a pair of brake devices coupled to the pair of drive wheels.

7. The electric driveline system of claim 1, wherein the first and second electric machines are coaxially arranged.

8. The electric driveline system of claim 7, further comprising a final gear reduction positioned between a differential and a carrier of the planetary gearset.

9. The electric driveline system of claim 1, wherein an axle shaft is coupled to a differential and extends through an opening in a sun gear of the planetary gearset.

10. The electric driveline system of claim 1, further comprising a heat exchanger coupled to a housing of the electric drive unit or a vehicle frame and configured to circulate a water based coolant therethrough.

11. The electric driveline system of claim 1, further comprising a mechanical power take-off (PTO) coupled to an output shaft of the first electric machine or the second electric machine.

12. A method for operation of an electric driveline system, comprising:
transferring rotational energy to a sun gear of a planetary gearset from a first electric machine and a second electric machine; and
shifting between a first gear configuration and a second gear configuration via:
engagement of a first friction clutch coupled to a ring gear of the planetary gearset; and
disengagement of a second friction clutch coupled to the sun gear of the planetary gearset; and
transferring rotational energy to a differential or axle shafts from a carrier in the planetary gearset.

13. The method of claim 12, wherein engagement of the first friction clutch and disengagement of the second friction clutch are synchronously implemented.

14. The method of claim 12, further comprising transferring rotational energy from the first electric machine to a mechanical power take-off (PTO) through operation of a PTO clutch coupled to an output shaft of the first electric machine and the mechanical PTO.

15. The method of claim 14, wherein the electric driveline system further comprises a third electric machine that mechanically drives a lubricant pump and the method further comprises:
transferring electric energy from a lower or higher voltage inverter to the third electric machine; and
transferring electric energy from lower or higher voltage inverters to the first and second electric machines.

16. An electric driveline system, comprising:
an electric drive unit including:
a planetary gearset with a sun gear rotationally coupled to a first electric machine and a second electric machine;
a differential rotationally coupled to a carrier in the planetary gearset;
a first friction clutch and a synchronizer coupled to a ring gear in the planetary gearset; and
a second friction clutch coupled to the sun gear; and
a driveline control unit (DCU) including instructions that when executed cause the DCU to:
operate the first friction clutch and the second friction clutch to synchronously shift between a first gear configuration and a second gear configuration.

17. The electric driveline system of claim 16, further comprising:
a third electric machine mechanically driving a lubricant pump;
wherein:
the third electric machine receives electric power from a lower voltage inverter and the first and second electric machines receive electric power from higher voltage inverters; or
the first electric machine, the second electric machine, and the third electric machine receive electric power from inverters that operate at a similar voltage.

18. The electric driveline system of claim 16, further comprising a mechanical power take-off (PTO) coupled to an output shaft of the first electric machine or the second electric machine.

19. The electric driveline system of claim 16, wherein the first and second electric machines are coaxially arranged.

20. The electric driveline system of claim 16, wherein the differential and the planetary gearset are coaxially arranged and wherein the differential is an open differential, a limited slip differential, or a torque vectoring differential.
